(19) United States
(12) Patent Application Publication
(10) Pub. No.: US 2009/0046064 A1
(43) Pub. Date: Feb. 19, 2009

(54) Pointing device for control of a graphical display or application

(75) Inventors: Gil Manalo, Redmond, WA (US); Amanda Yu-ching Wu, Seattle, WA (US); Babak Sayyadi, Bellevue, WA (US); Kevin Flick, Seattle, WA (US)

Correspondence Address: WESTMAN CHAMPLIN (MICROSOFT CORPORATION), SUITE 1400, 900 SECOND AVENUE SOUTH, MINNEAPOLIS, MN, 55402-3244, US

(73) Assignee: Microsoft Corporation, Redmond, WA (US)

(21) Appl. No.: 11/894,043

(22) Filed: Aug. 17, 2007

(51) Int. Cl. G06F 3/033

(52) U.S. Cl. 345/164; 345/163

(57) ABSTRACT

The application discloses a pointing to interface with a graphical display. In illustrated embodiments disclosed, the pointing device includes a plurality of vertically aligned side buttons. The vertically aligned side buttons are aligned relative to a user's thumb and are selectively actuated through a pivoting motion of the user's thumb. In another embodiment, one or more side buttons are adjustably coupled to the body of the pointing device to adjust a position of the one or more side buttons along a length of the device to provide enhanced dynamic control based upon the size and length of the user's thumb.

### BACKGROUND

Pointing devices are used to interface with a computer or electronic device, such as a personal computer or laptop computer. Pointing devices are generally used for desktop applications or to interface with a game application or program. For desktop applications, the pointing device is used to control a pointer or cursor on a screen to activate functions or features of an application or program. For game applications, pointing devices are used to control or move a figure or game icon on the graphical display.

For game or other applications, it is important that the user be able to execute various actions or sequence of actions at a rapid pace. In a rapid pace environment, both static comfort and dynamic control are important. The discussion above is merely provided for general background information and is not intended to be used as an aid in determining the scope of the claimed subject matter.

### SUMMARY

The application discloses a pointing device for control of graphical display or application program. In illustrated embodiments disclosed, the pointing device includes a plurality of vertically aligned side buttons. The vertically aligned side buttons are aligned relative to a user's thumb and are selectively actuated through a pivoting motion of the user's thumb. In another embodiment, one or more side buttons are adjustably coupled to the body of the pointing device to adjust the position of the one or more side buttons along a length of the device based upon the length or size of the user's thumb.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a schematic illustration of an embodiment of a pointing device and operating environment.

FIG. 2 is a schematic illustration of an embodiment of a wireless pointing device and operating environment.

FIG. 3 illustrates a side view of an embodiment of a pointing device disclosed in the application.

FIGS. 4-5 illustrate additional side views of the pointing device illustrated in FIG. 3.

FIG. 6 is a bottom view of the pointing device illustrated in FIGS. 3-5.

FIG. 7 is a detailed illustration of a side portion of the pointing device illustrated in FIG. 3 including a plurality of vertically aligned side buttons.

FIG. 8 is an illustration of an embodiment of a side panel forming the side portion of the pointing device illustrated in FIG. 7.

FIG. 9 is a schematic illustration of an embodiment of a pointing device having adjustable side buttons.

FIG. 10 is a flow chart for using a pointing device to interface with a graphical display.

### DETAILED DESCRIPTION

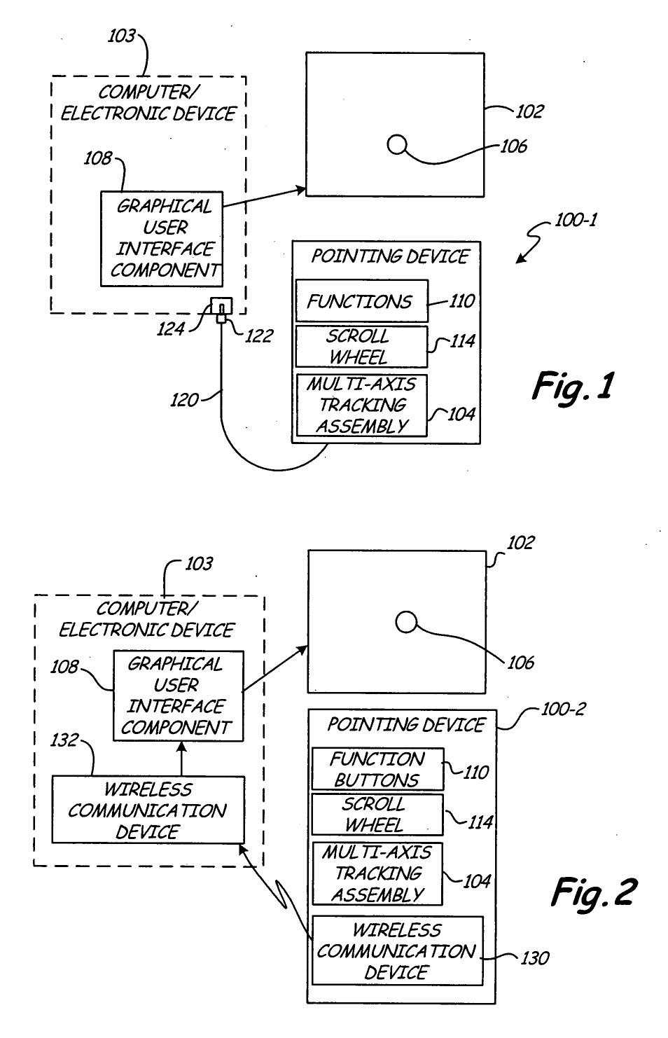

Pointing devices allow a user to interface with applications or programs on a computer device such as a personal computer, portable computer or other electronic device having a graphical user interface. FIG. 1 schematically illustrates an embodiment of a pointing device or mouse 100-1 that is configured to interface with a graphical user interface on a graphical display 102 of a computer or other electronic device 103. In the illustrated embodiment, the pointing device 100-1 includes a tracking assembly 104, which is configured to control a position of an object 106 on the graphical display 102. Illustratively, the object 106 can be a cursor, figure or other icon. The graphical display 102 can be generated through the graphical user interface component of an operating program or application such as Windows® available from Microsoft Corporation or directly through a game application or program that writes directly to a graphics driver or display 102.

The tracking assembly 104 is configured detect movement and output a control signal proportional to the detected movement. The control signal is processed by a graphical user interface component 108 to position the object 106 on the graphical display 102 in response to input from the pointing device 100-1.

In the illustrated embodiment, the tracking assembly 104 includes one or more sensor elements (not shown in FIG. 1) to detect multi-axial movement of the pointing device relative to a reference position. Illustrative sensor elements include mechanical sensor elements such as roller balls, optical sensor elements such as light-emitting diodes or photodiodes, or laser sensor elements which use an infrared laser to detect movement of the device. Application is not limited to the particular embodiment shown in FIG. 1, nor to the particular sensor elements described.

As shown in FIG. 1, in the illustrated embodiment, the pointing device 100-1 includes one or more buttons 110 to activate or execute various functions or features of the electronic device or application program. Illustratively, the various functions or features can be invoked directly through the pointing device or through icons on the graphical display 102. The illustrated device also includes a scroll wheel 114. The scroll wheel 114 is rotatable about a single axis to provide a one-dimensional input, which is used to scroll through an active display element, such as a text document or move an object 106 on the graphical display 102.

In an illustrated embodiment, the pointing device communicates with the graphical user interface component 108 through a cable 120 connected to or hard wired to circuitry of the pointing device 100-1. The cable 120 is connected to the computer or electronic device 103 via a connector plug 122 (illustrated schematically) insertable into a connector port 124 on the computer device. Although a cable connection is illustrated in FIG. 1, application is not limited to a pointing device coupled to the computer device 103 via a cable connection.

For example, in an alternate embodiment shown in FIG. 2, the pointing device 100-2 communicates with the computer or electronic device 103 through a wireless interface. The wireless interface includes a wireless communication device 130 coupled or connected to the pointer device 100-2 and a wireless communication device 132 coupled to the computer device 103. Output from the pointing device 100-2 is transmitted via the wireless communication device 130 to the wireless communication device 132 on the computer device 103 via known communication protocols. Illustratively the wireless communication device can utilize a RF communication protocol or other communication protocols. The transmitted output is processed by the graphical user interface component 108 to provide a user interface through the graphical display 102.

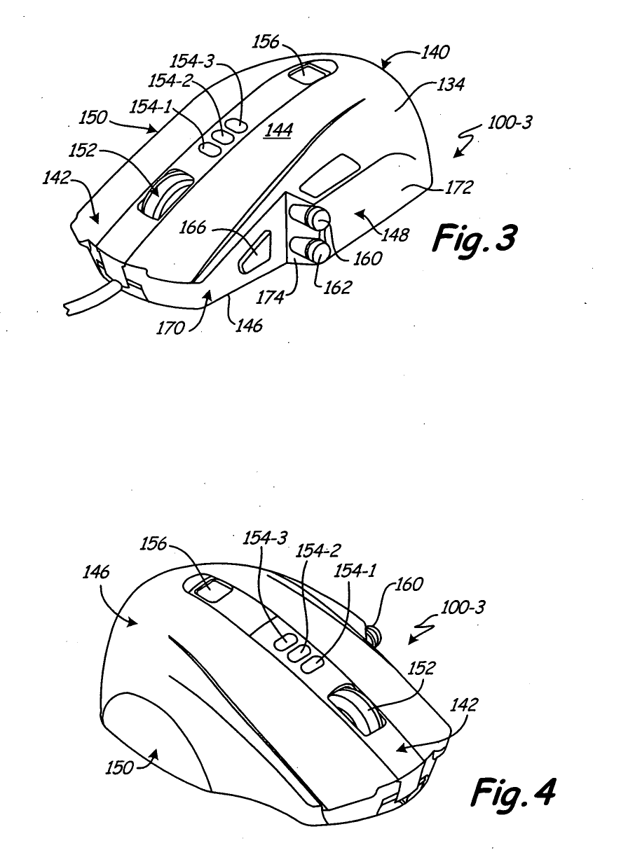

FIGS. 3-4 illustrates an embodiment of a pointing device 100-3 functionally similar to the pointing devices 100-1, 100-2 illustrated in FIGS. 1-2. The illustrated pointing device 100-3 includes a contoured body 134 having a forward portion 140 and a rear portion 142. As shown, the contoured body 134 also includes a top portion 144, elevated from a base 146 and first and second side portions 148, 150.

For use, a user's hand is supported along an upper surface of the top portion 144 of the device. A palm of the user's hand is supported proximate to the rear portion 140 of the device and the user's fingers and thumb are positioned along the forward portion 142 of the device.

In the illustrated embodiment, the top portion 144 includes a scroll wheel 152 and a plurality of top buttons. As previously described, the scroll wheel 152 is used to provide a one-dimensional control input. Illustratively, the scroll wheel 152 is used to move a figure or game object or alternately the scroll wheel 152 is used to scroll through an active display element, such as a text document.

In the illustrated embodiment, the plurality of top buttons includes a series of buttons for controlling resolution (or dots per inch (DPI)) of the pointing device 100-3 or tracking assembly of the pointing device 100-3 (not shown in FIGS. 3-4). The series of buttons allow the user to set or define the display resolution and thus movement of the object 106 on the graphical display 102 corresponding to detected movement of the device or tracking assembly 104.

In the illustrated embodiment, the series of buttons include a low DPI button 154-1, a medium DPI button 154-2 and a high DPI button 154-3. For a low DPI, button 154-1 is actuated to provide a lower display resolution. The lower resolution provides larger object 106 movement on the graphical display 102 corresponding to movement of the device or tracking assembly.

For medium DPI, button 154-2 is actuated to provide increased resolution and smaller object movement for a given movement of the device or tracking assembly. For high DPI or resolution, button 154-3 is actuated to provide even smaller object 106 movements relative to movement of the device or tracking assembly. In illustrated embodiments, the DPI resolution for buttons 154-1, 154-2, 154-3 can be pre-defined by the device manufacturer or selectively programmed by the user through device software.

Additionally, in the illustrated embodiment, the plurality of top buttons includes a shortcut button 156 configured to launch an application or program on the computer or electronic device 103. For example, the shortcut button 156 can be configured to launch a game explorer application or other application or program on the computer device 103. The function of the shortcut button 156 can be programmed by the device manufacturer or by the user through device software.

As shown in FIG. 3, the first side portion 148 includes a plurality of vertically aligned side buttons 160, 162. As shown, side button 160 is located directly above side button 162 to provide a plurality of buttons aligned along a vertical axis. In the illustrated embodiment, the device 100-3 is a right hand device and the first side portion 148 forms a left side of the device.

For use, the user's thumb is positioned proximate to the vertically aligned side buttons 160, 162 to selectively actuate one of the vertically aligned side buttons 160, 162 to activate one or more functions or features of the graphical display 102 or application. Alternatively, the first side portion 148 forms a right side of a left hand device so that the thumb of a left handed user is also located proximate to the vertically aligned side buttons to selectively actuate one of the vertically aligned side buttons 160, 162.

As previously described, the vertically aligned side buttons 160, 162 are selectively actuated via movement of the thumb. To actuate the upper side button 160, the user pivots their thumb upwardly to align with the upper side button 160. Thereafter, to actuate the lower side button 162, the user pivots their thumb downward to align with the lower side button 162.

In the illustrated embodiment, the first side portion 148 also includes a forward side button 166 located along the forward portion 142 of the device. In the illustrated embodiment, the forward side button 166 is positioned forward of the vertically aligned side buttons 160, 162. To actuate the forward button 166, the user advances or extends their thumb forward so that the thumb aligns with the forward side button 166 for actuation.

As shown in FIG. 3, the first side portion 148 is contoured to form a recessed side surface 170 spaced inwardly from a raised side surface 172 along the rear portion of the device. An inclined surface extends between the raised side surface 170 and the recessed side surface 172 to form an inclined step 174 generally traverse to the raised side surface 172 and recessed side surface 170.

As shown, the vertically aligned side buttons 160, 162 are located along the inclined step 174 and the forward side button 166 is located on the recessed side surface 170 forward of the inclined step 174. During use, the user's thumb abuts the inclined step 174 proximate to the vertically aligned side buttons 160, 162 to selectively actuate one or more of the vertically aligned buttons 160, 162 via pivoting action of the user's thumb. As shown, the inclined step 174 or surface forms a protruding edge to easily locate the side buttons 160, 162 and provide a convenient surface to rest the user's thumb.

In an illustrated embodiment, the vertically aligned side buttons 160, 162 are configured to execute a series of functions or actions. For example in a game application, the vertically aligned side buttons 160, 162 can be programmed to execute a sequence of one or more actions or commands in response to actuation of one of the vertically aligned side buttons. An illustrative sequence for a game application includes one or more action steps such as 1) firing shots at a target, 2) reloading and 3) firing additional shots at a target. Although an illustrative sequence is disclosed, application is not limited to the particular example or sequence disclosed. Illustratively, the actions or sequence can be pre-programmed with the device or programmed by the user.

In an illustrated embodiment, the forward button 166 is a record button, which is used to configure or program the actions or sequence for the plurality of vertically aligned buttons 160, 162. To program the actions or sequence, the user hits the record button 166 and one of the vertically aligned buttons 160 or 162. Thereafter, the user inputs one or more commands or actions via an input device such as a keyboard or other input device. Upon completion of the input process, the user hits the record button 166 again to record the sequence or one or more actions in memory along with an association of the recorded sequence or actions to the selected button. Thereafter, the user depresses or actuates one of the buttons 160, 162 to execute the recorded sequence or actions.

FIG. 4 illustrates the second side portion 150 of the device which in the illustrated embodiment is along the left side of the right hand device 100-3 shown. Alternatively, in an alternate embodiment, the second side portion forms the right side of a left hand device. The second side portion 150 has a rounded contour forming a wider profile proximate to the rear portion 140 and a narrower profile proximate to the forward portion 142. During use, the user's pinky and ring fingers are positioned along the second side portion 150.

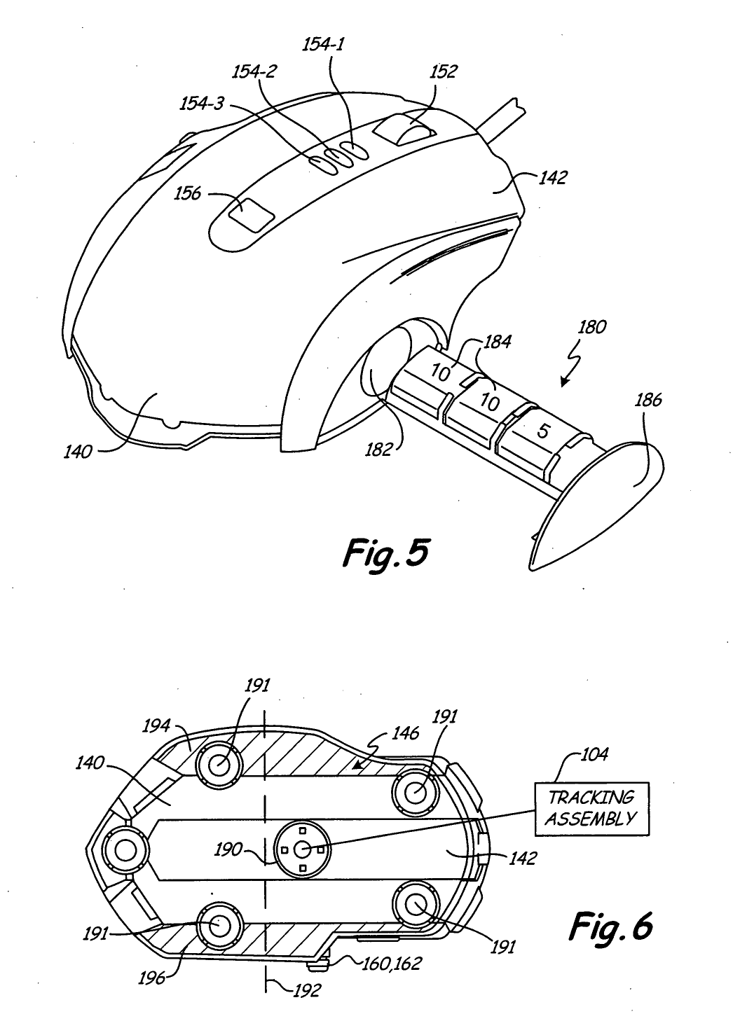

In the illustrated embodiment, the second side portion 150 includes a slidable tray 180 as shown in FIG. 5. The tray 180 slides through an opening 182 into an interior compartment of the device as shown in FIG. 5. The tray 180 supports one or more weights 184 to provide an adjustable weight device. For use, the tray 180 is slid out of the body of the device to load one or more weights 182 onto the tray 180. The weights 184 are loaded on or unloaded from the tray 180 to increase or decrease the weight of the device based on user preference. After the tray is 180 loaded, the tray 180 is slid through the opening 182 into the interior compartment until a side face 186 of the tray 180 abuts the side surface to close the tray 180 within the device.

As previously described, the top and side portions 144, 148, 150 are elevated from base 146. As shown in FIG. 6, the base 146 includes an opening 190 for the sensor element (or elements not shown in FIG. 6) of the tracking assembly 104. The sensor element (or elements) of the tracking assembly 104 detect movement of the device to position or aim the object 106 on the graphical display 102 as previously described. In the illustrated embodiment, feet 191 extend from the base 146 to contact an operating surface or desktop (now shown).

In the illustrated embodiment, the user grips the body of the device along a grip axis 192 located between the forward and rear portions 142, 140 of the device. As shown in FIG. 6, the grip axis 192 is located proximate to the vertically aligned side buttons 160, 162. During use, the device is gripped, lifted and moved relative to the grip axis 192. In the illustrated embodiment, the body of the device is weight balanced relative to the grip axis 192 or vertically aligned side buttons 160, 162. The weight balance proximate to the grip axis 192 or side buttons 160, 162 is designed to limit tipping.

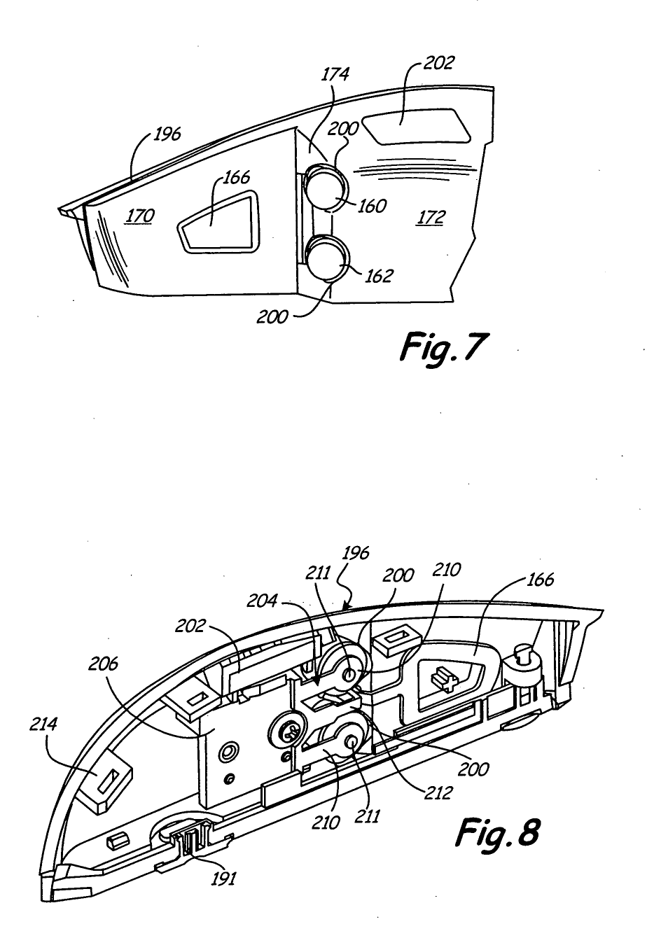

In an illustrated embodiment, the device is formed of assembly components that are connected to form the body 134 of the device. As shown in FIG. 6, the assembly components include side panels 194, 196, which connect to other components to form the body of the device. FIG. 7 illustrates an outer portion of side panel 196, which as shown is contoured to form the recessed side surface 170, raised side surface 172 and the inclined step 174 of the first side portion of the device as previously described. As shown, side buttons 160, 162 extend through openings 200 along the surface of the inclined step 174. In the illustrated embodiment, a rear portion of the panel 196 includes an LCD display 202, which illustratively displays DPI settings or other configurations of the device.

FIG. 8 illustrates an inner view of side panel 196 and components. As shown, buttons 160, 162 extend through openings 200 and connect to a spring assembly 204 coupled to a circuit component or board 206 through switch component(s) (not shown). As shown, the spring assembly 204 includes a plurality of flexible tabs 210. Buttons 160, 162 are connected to the flexible tabs 210 via pins 211 or other attachment. Tabs 210 are electrically coupled to the circuit component or board 206 through switch components (not shown) to provide an electrical interface to activate one or more functions or a sequence of one or more action steps associated with the vertically aligned side buttons 160, 162.

The buttons 160, 162 are spring actuated to limit inadvertent actuation. For actuation, the buttons are depressed inwardly to move tabs 210 against a spring bias to activate the associated function or sequence of the buttons 160 or 162. In the illustrated embodiment, the vertically aligned side buttons 160, 162 are formed of a metal material although application is not limited to the particular embodiment disclosed in FIGS. 3-8.

In the embodiment shown in FIG. 8, the forward button 166 is also coupled to a spring tab 212. The forward button 166 is actuated against the bias of spring tab 212 to activate the record functions or other function associated with the forward button 166. Upon actuation, the spring tab 212 moves against the spring bias to provide an electrical interface to the circuit component or board 206 as previously described. Additionally as shown, panel 196 includes prongs 214 to attach the panel 196 to other components to form the body of the device 100-3.

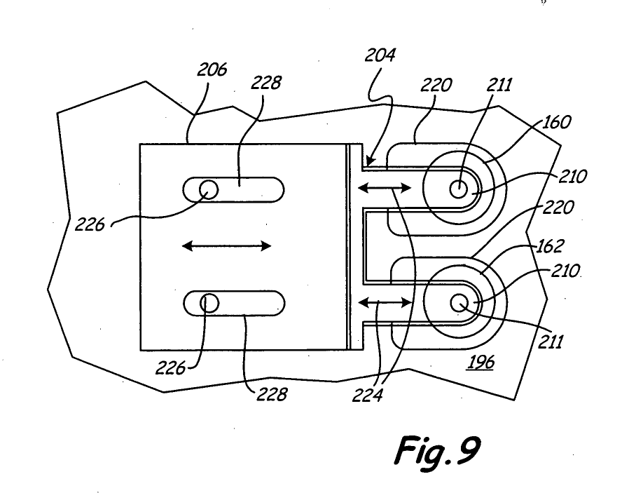

FIG. 9 illustrates an embodiment of a side portion having adjustable side buttons. In the illustrated embodiment, the adjustable side buttons includes the vertically aligned side buttons 160, 162. The vertically aligned side buttons 160, 162 are adjusted to adjust a position of the buttons for alignment with the user's thumb.

As schematically shown, the position of the buttons 160, 162 is adjustable along slots 220 as illustrated by arrow 224. As illustrated the circuit component or board 206 is also slidably coupled to panel 196 via pins 226 slidable along elongate slots 228 on the circuit board or panel 196. Thus, the vertically aligned side buttons 160, 162 and circuit component or board 206 are both slidably moved as illustrated by arrow 224 to adjust a longitudinal position of the buttons 160, 162 along the length of the device. The longitudinal position of the buttons 160,162 is adjusted based upon the size or length of the user's thumb to provide enhance dynamic comfort and control.

Although FIG. 9 illustrates adjustment of the vertically aligned side buttons 160, 162, application is not limited to adjustable side buttons 160, 162 as shown and one or more side buttons can be adjustably mounted to the body of the device as described to accommodate different hand sizes.

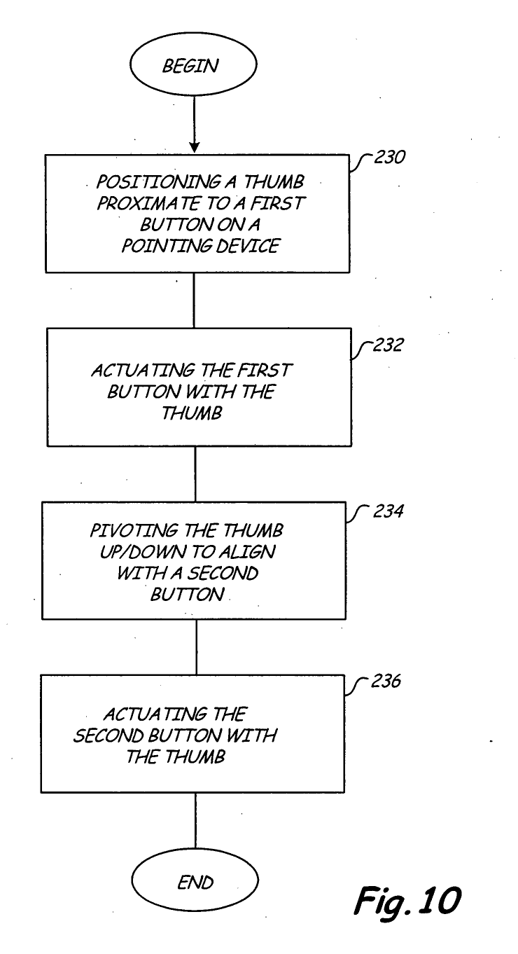

FIG. 10 illustrates a flow chart illustrating a user interface with a graphical display 102. As illustrated in step 230, a user's thumb is positioned proximate to a first button, for example one of the vertically aligned side buttons 160 or 162. Button 160 or 162 is actuated in step 232. For example, the button 160 or 162 is actuated in step 232 by depressing the button 160 or 162 inwardly as described. To actuate a second button 160 or 162, the user pivots their thumb up or down to align with the second button as illustrated in step 234. Thereafter in step 236, the second button 160 or 162 is actuated as previously described. In another embodiment, the user extends their thumb forward to actuate another button forward of the vertically aligned side buttons 160, 162.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A pointing device comprising:
a body having a top portion, a base and at least one side portion between the top portion and the base;
a tracking assembly including at least one sensor to detect movement and output a control signal responsive to the detected movement; and
a plurality of vertically aligned side buttons on the at least one side portion.

2. The pointing device of claim 1 wherein the plurality of vertically aligned side buttons is formed of a metal material.

3. The pointing device of claim 1 wherein the at least one side portion includes a raised side surface, a recessed side surface and an inclined stepped surface between the raised side surface and the recessed side surface.

4. The pointing device of claim 3 wherein the plurality of vertically aligned side buttons is formed on the inclined stepped surface.

5. The pointing device of claim 1 wherein at least one of the plurality of vertically aligned side buttons is configured to execute an action or sequence for a game application or program.

6. The pointing device of claim 1 and further comprising at least one side button laterally spaced from the plurality of vertically aligned side buttons.

7. The pointing device of claim 6 wherein the at least one side button laterally spaced from the plurality of vertically aligned side buttons is positioned forward of the plurality of vertically aligned side buttons.

8. The pointing device of claim 6 wherein the at least one side portion includes a raised side surface, a recessed side surface and an inclined stepped surface and the at least one side button laterally spaced from the plurality of vertically aligned side buttons is on the recessed side surface.

9. The pointing device of claim 6 wherein the at least one side button laterally spaced from the plurality of vertically aligned side buttons is a record button.

10. The pointing device of claim 1 wherein the body of the pointing device is weight balanced about a grip axis.

11. The pointing device of claim 1 wherein the body of the pointing device is weight balanced relative to the plurality of vertically aligned side buttons.

12. The pointing device of claim 1 wherein the plurality of vertically aligned side buttons are coupled to a spring assembly and are depressed against a spring bias to activate a function or action associated with the plurality of vertically aligned side buttons.

13. The pointing device of claim 1 wherein a position of the vertically aligned side buttons is adjustable.

14. A pointing device comprising:
a body having a base, a top portion and at least one side portion;
a tracking assembly including at least one sensor to detect movement and output a control signal responsive to the detected movement;
at least one side button slideably adjustable along a length of the body to adjust a position of the at least one side button.

15. The pointing device of claim 14 and comprising a plurality of vertically aligned side buttons adjustable along the length of the pointing device.

16. The pointing device of claim 15 and comprising at least one side button laterally spaced from the plurality of vertically aligned side buttons.

17. A method for controlling a computer or electronic device comprising:
gripping a pointing device;
actuating a first button to execute a first action by depressing the first button with a thumb;
pivoting the thumb to reposition the thumb proximate to a second button; and
actuating the second button to execute a second action by depressing the second button with the thumb.

18. The method of claim 17 wherein prior to actuating the first and second buttons comprising:
programming at least one of the first or second buttons to execute a sequence of one or more actions in a game application or program.

19. The method of claim 17 and further comprising:
extending the thumb to actuate a third button laterally spaced from the first and second buttons.

20. The method of claim 17 and further comprising:
adjusting a position of the first and second buttons along a length of the pointing device.
